(19) United States
(12) Patent Application Publication
(10) Pub. No.: US 2014/0063880 A1
(43) Pub. Date: Mar. 6, 2014

(54) RECTIFIER CIRCUIT AND ELECTRONIC DEVICE USING SAME

(71) Applicant: HON HAI PRECISION INDUSTRY CO., LTD., New Taipei (TW)

(72) Inventors: CHUANG-WEI TSENG, New Taipei (TW); KAI-FU CHEN, New Taipei (TW); CHE-HSUN CHEN, New Taipei (TW)

(73) Assignee: HON HAI PRECISION INDUSTRY CO., LTD., New Taipei (TW)

(21) Appl. No.: 14/014,400

(22) Filed: Aug. 30, 2013

(30) Foreign Application Priority Data
Sep. 4, 2012 (TW) 101132153

(51) Int. Cl. H02M 7/217

(52) U.S. Cl. CPC H02M 7/217
USPC 363/89

(57) ABSTRACT

A rectifier circuit includes a first alternating current (AC) voltage input terminal, a second AC voltage input terminal, a signal generating circuit, a first energy generating circuit, a second energy generating circuit, a third energy generating circuit, a first output terminal, and a second output terminal The first and second AC voltage input terminals receive an AC voltage. The signal generating circuit generates control signals. The first energy storing circuit is charged by the AC voltage. In a positive period of the AC voltage, the first energy storing circuit discharges to the second energy storing circuit. In a negative period of the AC voltage, the first energy storing circuit discharges to the third energy storing circuit The second energy storing circuit and the third energy storing circuit discharge to a load via the first output terminal

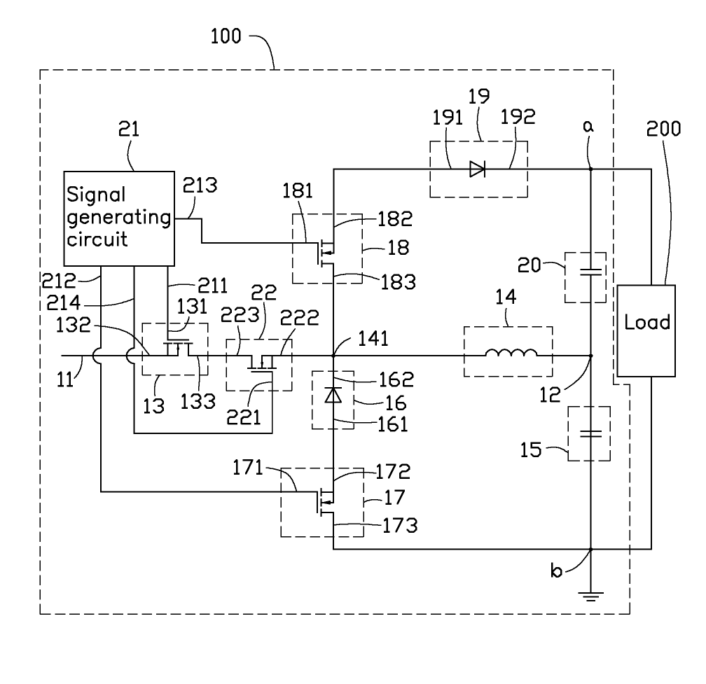

### BACKGROUND

1. Technical Field

The present disclosure relates to voltage rectifying technologies, and more particularly to a rectifier circuit having a power factor correction function and an electronic device using the same.

2. Description of Related Art

When an alternating current (AC) voltage is converted into a direct current (DC) voltage, a converter is needed. A boost circuit is an example of a converter. When the boost circuit is used, a DC voltage generated by the converter can be too great to be directly used by an electronic device. Thus, a transformer is needed to convert the DC voltage into a suitable voltage for the electronic device. However, the circuit will require more space to place the transformer.

Therefore, what is needed is to provide a means that can overcome the above-described limitations.

### BRIEF DESCRIPTION OF THE DRAWINGS

The components in the drawings are not necessarily drawn to scale, the emphasis instead placed upon clearly illustrating the principles of at least one embodiment. In the drawings, like reference numerals designate corresponding parts throughout the various views, and all the views are schematic.

The figure is a circuit diagram of a rectifier circuit powering a load according to one embodiment of present disclosure.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

Referring to the figure, a circuit diagram of a rectifier circuit 100 powering a load 200 is shown, according to one embodiment of the present disclosure. The rectifier circuit 100 receives an AC voltage, and converts the AC voltage into a DC voltage. The DC voltage serves as a driving voltage for the load 200. The AC voltage has a periodic and sinusoidal waveform, and includes a positive period and a negative period. A voltage value of the AC voltage is greater than zero in the positive period, and less than zero in the negative period.

The rectifier circuit 100 includes a first AC voltage input terminal 11, a second AC voltage input terminal 12, a signal generating circuit 21, a first switch 13, a second switch 22, a third switch 17, a fourth switch 18, a first unidirectional circuit 16, a second unidirectional circuit 19, a first energy storing circuit 14, a second energy storing circuit 15, a third energy storing circuit 20, a first output terminal a, and a second output terminal b.

The first AC voltage input terminal 11 and the second AC voltage input terminal 12 receive an AC voltage. The signal generating circuit 21 includes a first terminal 211, a second terminal 212, a third terminal 213, and a fourth terminal 214. The signal generating circuit 21 generates a first control signal, a second control signal, a third control signal, and a fourth control signal. The first control signal is output via the first terminal 211. The second control signal is output via the second terminal 212. The third control signal is output via the third output terminal 213. The fourth control signal is output via the fourth control terminal 214. The first control signal, the second control signal, the third control signal, and the fourth control signal are periodical signals. In the embodiment, the first control signal, the second control signal, the third control signal, and the fourth control signal are pulse width modulation (PWM) signals, which duty ratio can be modulated. Frequencies of the four control signals are greater than a frequency of the AC voltage. In the embodiment, the frequencies of the four control signals are integer times greater than the frequency of the AC voltage. Each period of the first control signal, the second control signal, the third control signal, and the fourth control signal includes a first half period and a second half period. For example, a voltage of the first half period of the first control signal is greater than zero, and a voltage of the second half period of the first control signal is less than zero. In the embodiment, each first half period of the four control signals occurs at the same time, and each second half period of the four signals occurs at the same time.

In the embodiment, the first switch 13, the second switch 22, the third switch 17, and the fourth switch 18 are N-channel metal-oxide semiconductor field-effect transistors (NMOSFET). The first switch 13 includes a first gate 131, a first drain 132, and a first source 133. The first gate 131 is electronically coupled to the first terminal 211. The first gate 131 receives the first control signal output from the first terminal 211, and controls the first switch 13 to switch on or off according to the first control signal. The first drain 132 is electronically coupled to the first AC voltage input terminal 11.

The second switch 22 includes a second gate 221, a second drain 222, and a second source 223. The second gate 221 is electronically coupled to the second terminal 212. The second gate 221 receives the second control signal output from the second terminal 212, and controls the second switch 22 to switch on or off according to the second control signal. The second source 223 is electronically coupled to the first source 133. The second drain 222 is electronically connected to the second AC voltage input terminal 12 via the first energy storing circuit 14. In the embodiment, the first energy storing circuit 14 is an inductor.

The third switch 17 includes a third gate 171, a third drain 172, and a third source 173. The third gate 171 is electronically coupled to the third terminal 213. The third gate 171 receives the third control signal output from the third terminal 213, and controls the third switch 17 to switch on or off according to the third control signal. The third source 173 is grounded. The third drain 172 is electronically coupled to a node 141 via the first unidirectional circuit 16. The node 141 is between the second drain 222 of the second switch 22, and the first energy storing circuit 14. In the embodiment, the first unidirectional circuit 16 is a diode, which includes a first anode 161 and a first cathode 162. The first anode 161 is electronically coupled to the third drain 172, and the first cathode 162 is electronically coupled to the node 141. The first unidirectional circuit 16 turns on when a voltage of the first anode 161 is greater than a voltage of the first cathode 162, and turns off when the voltage of the first anode 161 is less than the voltage of the first cathode 162.

The fourth switch 18 includes a fourth gate 181, a fourth drain 182, and a fourth source 183. The fourth gate 181 is electronically coupled to the fourth terminal 214. The fourth gate 181 receives the fourth control signal output from the fourth terminal 214, and controls the fourth switch 18 to switch on or off according to the fourth control signal. The fourth source 183 is electronically coupled to the node 141. The fourth drain 182 is electronically coupled to the first output terminal a via the second unidirectional circuit 19.

In the embodiment, the second unidirectional circuit 19 includes a diode. The second unidirectional circuit 19 includes a second anode 191 and a second cathode 192. The second anode 191 is electronically coupled to the fourth drain 182. The second cathode 192 is electronically coupled to the first output terminal a. The second unidirectional circuit 19 turns on when a voltage of the second anode 191 is greater than a voltage of the second cathode 192, and the second unidirectional circuit 19 turns off when the voltage of the second anode 191 is less than the voltage of the second cathode 192.

The third energy storing circuit 20 is electronically coupled between the first output terminal a and the second AC voltage input terminal 12. The second energy storing circuit 15 is electronically coupled between the second AC voltage input terminal 12 and the ground via the second output terminal b. In the embodiment, the second energy storing circuit 15 and the third energy storing circuit 20 are capacitors.

The conversion of the AC voltage into the DC voltage is described below.

When the AC voltage is in the positive period, the first switch 13 switches on during the first half period of the first control signal, and switches off during the second half period of the first control signal. The second switch 22 switches on when the first switch 13 switches on, and the second switch 22 switches off when the first switch 13 switches off, under the control of the second control signal. That is, the second switch 22 switches on during the first half period of the second control signal, and switches off during the second half period of the second control signal. The third switch 17 switches off in the first half period of the third control signal and switches on in the second half period of the third control signal. The fourth switch 18 switches off both in the first half period and the second half period of the fourth control signal. When the AC voltage is in the positive period, the first energy storing circuit 14 stores energy during the first half period of the control signals. The first energy storing circuit 14 discharges to the second energy storing circuit 15 during the second half period of the control signals, thereby charging the second energy storing circuit 15.

When the AC voltage is in the negative period, the first switch 13 switches on during the first half period of the first control signal, and switches off during the second half period of the first control signal. The second switch 22 switches on when the first switch 13 switches on, and the second switch 22 switches off when the first switch 13 switches off under the control of the second control signal. That is, the second switch 22 switches on during the first half period of the first control signal, and switches off during the second half period of the first control signal. The third switch 17 switches off during the first half period and the second half period of the third control signal. The fourth switch 18 switches off during the first half period of the fourth control signal, and switches on during the second half period of the fourth control signal. When the AC voltage is in the negative period, the first energy storing circuit 14 stores energy during the first half period of the control signals, and the first energy storing circuit 14 discharges to the third energy storing circuit 20 during the second half period of the control signals, thereby charging the third energy storing circuit 20.

The second energy storing circuit 15 and the third energy circuit 20 are fully charged after several periods of the AC voltage. The time to fully charge the second energy storing circuit 15 and the third energy circuit 20 relates to a voltage value of the AC voltage, and a capacitance of the second energy storing circuit 15 and the third energy storing circuit 20.

After the second energy storing circuit 15 and the third energy storing circuit 20 are fully charged, an operation principle of the rectifier 100 is described in detail below.

When the AC voltage is in the positive period, in the first half period of the control signals, the first energy storing circuit 14 stores energy. At the same time, the second energy storing circuit 15 and the third energy storing circuit 20 discharge to the load 200 via the first output terminal a. In the second half period of the control signals, the first energy storing circuit 14 discharges to the second energy storing circuit 15. At the same time, the second energy storing circuit 15 and the third energy storing circuit 20 discharge to the load 200 via the first output terminal a.

When the AC voltage is in the negative period, in the first half period of the control signals, the first energy storing circuit 14 stores energy. At the same time, the second energy storing circuit 15 and the third energy storing circuit 20 discharge to the load 200 via the first output terminal a. In the second half period of the control signals, the first energy storing circuit 14 discharges to the third energy storing circuit 20. At the same time, the second energy storing circuit 15 and the third energy storing circuit 20 discharge to the load 200 via the first output terminal a. In the positive period and the negative period of the first AC voltage, when the first energy circuit 14 discharges to the second energy circuit 15 and the third energy storing circuit 20, a DC voltage is generated. Therefore, the AC voltage is converted into a DC voltage.

According to the voltage second balance principle, a peak voltage value of the DC voltage to a peak voltage value of the AC voltage is 2D/(1-D), wherein the D is a duty ratio of the first control signal. The first control signal is a PWM signal, and the duty ratio of the first control signal can be modulated. Therefore, the voltage value of the DC voltage can be modulated. That is, the voltage value of the DC voltage can be modulated greater than or less than the voltage value of the AC voltage. Therefore, a transformer is not needed in the rectifier circuit 100, and less space is needed.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A rectifier circuit, comprising:
a first alternating current (AC) voltage input terminal;
a second AC voltage input terminal; the first AC voltage input terminal and the second AC voltage input terminal receiving an AC voltage;
a signal generating circuit generating control signals;
a first energy storing circuit charged by the AC voltage;
a second energy storing circuit;
a third energy storing circuit;
a first output terminal;
a second output terminal, the second energy storing circuit and the third energy storing circuit are connected in series and coupled between the first output terminal and the second output terminal; the second energy storing circuit and the third energy storing circuit configured to drive a load between the first output terminal and the second output terminal;
wherein during a positive period of the AC voltage the first energy storing circuit discharges to the second energy storing circuit; during a negative period of the AC voltage the first energy storing circuit discharges to the third energy storing circuit.

2. The rectifier circuit according to claim 1, wherein the control signals are periodical signals, and comprises a first half period and a second half period in a cycle; during the positive period of the AC voltage, the first energy storing circuit is charged by the AC voltage during the first half period of the control signals and the first energy storing circuit discharges to the second energy storing circuit during the second half period of the control signals; during the negative period of the AC voltage, the first energy storing circuit is charged by the AC voltage during the first half period of the control signals and the first energy storing circuit discharges to the third energy storing circuit in the second half period of the control signals.

3. The rectifier circuit according to claim 2, wherein during the negative period of the AC voltage, the first energy storing circuit is charged by the AC voltage during the first half period of the control signals and the first energy storing circuit discharges to the third energy storing circuit during the second half period of the control signals; during the negative period of the AC voltage, the first energy storing circuit is charged by the AC voltage during the first half period of the control signals and the first energy storing circuit discharges to the second energy storing circuit during the second half period of the control signals.

4. The rectifier circuit according to claim 2, wherein the rectifier circuit further comprises a first switch, a second switch a third switch and a fourth switch; the first switch, the second switch and the first energy storing circuit are electronically coupled in series and electronically coupled between the first AC voltage input terminal and the second AC voltage input terminal; the third switch is electronically between a node formed between the second switch and the second output terminal; the fourth switch is electronically between the node and the first output terminal; during the positive period of the AC voltage, the first switch switches on during the first half period of the control signal and switches off during the second half period of the control signal; the second switch switches on when the first switch switches on and switches off when the first switch switches off; the third switch switches off during the first half period of the control signal and switches on during the second half period of the control signal; the fourth switch switches off both during the first half period and the second half period of the control signal.

5. The rectifier circuit according to claim 4, wherein during the negative period of the AC voltage the first switch switches on during the first half period of the control signal and switches off during the second half period of the control signal; the second switch switches on when the first switch switches on and switches off when the first switch switches off; the third switch switches off both during the first half period and the second half period of the control signal; the fourth switch switches off during the first half period of the control signal and switches on during the second half period of the control signal.

6. The rectifier circuit according to claim 4, the rectifier circuit further comprises a first unidirectional circuit and a second unidirectional circuit; the first unidirectional circuit comprises a first anode and a first cathode, the first anode is electronically coupled between the fourth switch and the first output terminal, and the first anode is electronically coupled to the fourth switch; when an voltage of the first anode is greater than an voltage value of the first cathode, the first unidirectional circuit is on; when the voltage value of the first anode is less than the voltage of the first cathode, the first unidirectional circuit is off; the second unidirectional circuit comprises a second anode and a second cathode, the second unidirectional circuit is electronically coupled between the node and the fourth switch, and the second anode is electronically coupled to the third switch; when an voltage of the second anode is greater than an voltage value of the second cathode, the second unidirectional circuit is on; when the voltage value of the second anode is less than the voltage of the second cathode, the second unidirectional circuit is off.

7. The rectifier circuit according to claim 6, wherein the first and the second unidirectional circuit are diodes; first anode and the second anode are anodes of the diodes, the first cathode and the second cathode are cathodes of the diodes.

8. The rectifier circuit according to claim 4, wherein the first switch, the second switch, the third switch and the fourth switch are n-channel metal oxide semiconductor (NMOS) field effect transistors (FET).

9. The rectifier circuit according to claim 8, wherein the first switch comprises a first gate, a first drain and a first source; the second switch comprises a second gate, a second drain and a second source; the third switch comprises a third gate, a third drain and a third source; the fourth switch comprises a fourth gate, a fourth drain and a fourth source; the first gate, the second gate, the third gate and the fourth gate receive the control signals, the first drain is connected to the first AC voltage input terminal, the first source is connected to the second source, the second drain is connected to the first energy storing circuit, the third drain is electronically coupled to the node, the third source is connected to the second output terminal, the fourth drain is electronically coupled to the first output terminal and the third source is connected to the node.

10. The rectifier circuit according to claim 1, wherein the first energy storing circuit is an inductor, the second energy storing circuit and the third energy storing circuit are capacitors.

11. An electronic device comprising:
a first AC voltage input terminal;
a second AC voltage input terminal; the first AC voltage input terminal and the second AC voltage input terminal receiving an AC voltage;
a signal generating circuit generating control signals;
a first energy storing circuit charged by the AC voltage;
a second energy storing circuit;
a third energy storing circuit;
a first output terminal;
a load coupling between the first output terminal and the second output terminal;
a second output terminal, the second energy storing circuit and the third energy storing circuit are connected in series and coupled between the first output terminal and the second output terminal; the second energy storing circuit and the third energy storing circuit configured to drive the load;
wherein in a positive period of the AC voltage the first energy storing circuit only discharges to the second energy storing circuit; in a negative period of the AC voltage the first energy storing circuit only discharges to the third energy storing circuit; the second energy storing circuit and the third energy storing circuit discharge to the load via the first output terminal.

12. The electronic device according to claim 11, wherein the control signals are periodical signals, and comprises a first half period and a second half period in a cycle; during the positive period of the AC voltage, the first energy storing circuit is charged by the AC voltage during the first half period of the control signals and the first energy storing circuit discharges to the second energy storing circuit during the second half period of the control signals; during the negative period of the AC voltage, the first energy storing circuit is charged by the AC voltage during the first half period of the control signals and the first energy storing circuit discharges to the third energy storing circuit during the second half period of the control signals.

13. The electronic device according to claim 12, wherein during the negative period of the AC voltage, the first energy storing circuit is charged by the AC voltage during the first half period of the control signals and the first energy storing circuit discharges to the third energy storing circuit during the second half period of the control signals; during the negative period of the AC voltage, the first energy storing circuit is charged by the AC voltage during the first half period of the control signals and the first energy storing circuit discharges to the second energy storing circuit during the second half period of the control signals.

14. The electronic device according to claim 12, wherein the rectifier circuit further comprises a first switch, a second switch a third switch and a fourth switch; the first switch, the second switch and the first energy storing circuit are electronically coupled in series and electronically coupled between the first AC voltage input terminal and the second AC voltage input terminal; the third switch is electronically between a node formed between the second switch and the second output terminal; the fourth switch is electronically between the node and the first output terminal; during the positive period of the AC voltage, the first switch switches on during the first half period of the control signal and switches off during the second half period of the control signal; the second switch switches on when the first switch switches on and switches off when the first switch switches off; the third switch switches off during the first half period of the control signal and switches on during the second half period of the control signal; the fourth switch switches off both during the first half period and the second half period of the control signal.

15. The electronic device according to claim 14, wherein during the negative period of the AC voltage the first switch switches on during the first half period of the control signal and switches off during the second half period of the control signal; the second switch switches on when the first switch switches on and switches off when the first switch switches off; the third switch switches off both during the first half period and the second half period of the control signal; the fourth switch switches off during the first half period of the control signal and switches on during the second half period of the control signal.

16. The electronic device according to claim 14, the rectifier circuit further comprises a first unidirectional circuit and a second unidirectional circuit; the first unidirectional circuit comprises a first anode and a first cathode, the first anode is electronically coupled between the fourth switch and the first output terminal, and the first anode is electronically coupled to the fourth switch; when an voltage of the first anode is greater than an voltage value of the first cathode, the first unidirectional circuit is on; when the voltage value of the first anode is less than the voltage of the first cathode, the first unidirectional circuit is off; the second unidirectional circuit comprises a second anode and a second cathode, the second unidirectional circuit is electronically coupled between the node and the fourth switch, and the second anode is electronically coupled to the third switch; when an voltage of the second anode is greater than an voltage value of the second cathode, the second unidirectional circuit is on; when the voltage value of the second anode is less than the voltage of the second cathode, the second unidirectional circuit is off.

17. The electronic device according to claim 16, wherein the first and the second unidirectional circuit are diodes; first anode and the second anode are anodes of the diodes, the first cathode and the second cathode are cathodes of the diodes.

18. The electronic device according to claim 14, wherein the first switch, the second switch, the third switch and the fourth switch are n-channel metal oxide semiconductor (NMOS) field effect transistors (FET).

19. The electronic device according to claim 18, wherein the first switch comprises a first gate, a first drain and a first source; the second switch comprises a second gate, a second drain and a second source; the third switch comprises a third gate, a third drain and a third source; the fourth switch comprises a fourth gate, a fourth drain and a fourth source;
the first gate, the second gate, the third gate and the fourth gate receive the control signals, the first drain is connected to the first AC voltage input terminal, the first source is connected to the second source, the second drain is connected to the first energy storing circuit, the third drain is electronically coupled to the node, the third source is connected to the second output terminal, the fourth drain is electronically coupled to the first output terminal and the third source is connected to the node.

20. The electronic device according to claim 11, wherein the first energy storing circuit is an inductor, the second energy storing circuit and the third energy storing circuit are capacitors.
